(19) United States
(12) Patent Application Publication
(10) Pub. No.: US 2026/0222854 A1
(43) Pub. Date: Jul. 30, 2026

(54) A METHOD OF PERFORMING SENSING MEASUREMENTS BETWEEN A WIRELESS STATION, STA, AND AN ACCESS POINT ASSEMBLY, AP ASSEMBLY, AS WELL AS A CORRESPONDING AP ASSEMBLY

(71) Applicant: Telefonaktiebolaget LM Ericsson (publ), Stockholm (SE)

(72) Inventors: Leif WILHELMSSON, Lund (SE); Miguel LOPEZ, Aachen (DE)

(21) Appl. No.: 19/146,734

(22) PCT Filed: Jan. 10, 2023
(86) PCT No.: PCT/EP2023/050440

§ 371 Date: Jul. 9, 2025

(51) Int. Cl. H04W 24/08

(52) U.S. Cl. CPC H04W 24/08

(57) ABSTRACT

A method of performing sensing measurements between a wireless station, STA, and an access point assembly, AP assembly, in a wireless communication network, wherein the access point assembly is arranged to communicate with said STA using two distinct frequency bands. The method includes determining, by the AP assembly, which of the two distinct frequency bands to use for performing the sensor measurements and performing, by the AP assembly, the sensing measurements on the determined distinct frequency band.

A method of performing sensing measurements between a wireless station, STA, and an access point assembly, AP assembly, as well as a corresponding AP assembly.

### TECHNICAL FIELD

The present disclosure generally relates to the field of wireless communications and, more specifically, to a method of performing sensing measurements.

### BACKGROUND

Wireless sensing may use radio signals to detect objects or movement in the environment. Wireless sensing may also be used to estimate the quality of a wireless channel between a transmitter and a receiver. There has been an increased interest in using the same signal for sensing that is used for communication, or at least reuse the same hardware for generating the signals used for sensing that is used for generating the communication signal. Sometimes this is referred to as joint communication and sensing, JCAS.

Within wireless communication, there is a trend to use higher frequency bands, like 60 GHz or even higher. The primary reason for this is that more bandwidth is available in bands at higher frequency. Using a higher frequency band has both advantages and disadvantages.

Among the disadvantages is perhaps the most pronounced the higher pathloss, leading to that the coverage area for a transmission in a higher frequency band is often significantly smaller than if a lower frequency band would have been used for the transmission.

However, in some situations, where it is desirable to reuse the same channel in cells that are relatively close to one another, the high propagation loss may be an advantage due to that the co-channel interference will be less severe.

Among the advantages the above-mentioned larger bandwidth is probably the most important. When used for communication, this can be used to achieve a higher data rate, whereas when it is used for wireless sensing, the increased bandwidth can be used to enhance the sensing accuracy. Here, sensing accuracy may e.g. be how accurate a position can be determined or how small movements can be detected.

Because of the very different properties of lower frequency bands, say, below 7 GHz, and higher frequency bands, around 60 GHz and higher, it is known that both bands are supported by a single device. The lower band may then be used when a device is relatively far from the network node, whereas the higher band may be used when the device is relatively close to the network node.

The difference in coverage for the two bands may also be exploited to efficiently assign different devices to the different bands depending on whether the device is moving fast or is relatively static. Specifically, if a device is moving relatively fast, it is typically better to allocate a channel in the lower band to this device in order to avoid that the device has to do a lot of handovers between different cells.

A static device, on the other hand, will be connected to the same network node without the need for a handover, and then it may be preferable to allocate such a device to a channel in the higher frequency band in order to allow for using a channel with a larger channel bandwidth.

In addition, devices operating in different frequency bands are often subject to different regulations regarding the maximum output power depending on the geographical location. For example, in the USA, a Wireless Local Area Network, WLAN, Access Point, AP, operating in the 2.4 GHz may have an output power of 30 dBm while a very low power AP operating in 6 GHz must have an output power not exceeding 14 dBm.

Also, device manufacturers often limit the maximum output power of a device well below the regulatory requirements, due to e.g. size constraints because of the need for tight chip integration, need to lower the power consumption of the radio etc.

In practice, the output power constraints further exacerbate the imbalance in coverage. That is, in practice almost always the low bands offer better coverage than the high bands, although in some exceptional circumstances a radio operating in a high band (e.g. 60 GHz) may have better coverage than one in a low band (e.g. 5 GHz) due to higher output power and antenna gain in the higher band. This can e.g. happen for outdoor fixed wireless access points.

Wireless sensing may be performed using different approaches. It may be performed by a single device which then contains both the transmitter and the receiver. This is commonly referred to as mono-static sensing. Very often the approach is to send a pulse and then use the reflection to determine distance and/or Doppler of an object. If several monostatic sensing measurements are combined, one may e.g. use triangulation to determine the position. Naturally, if the distance is short the device may still be transmitting when the reflected pulse arrives putting hard requirements on being able to simultaneous transmit and receive operations.

Another approach for performing sensing is to involve two devices, the first one being the transmitter and the second one being the receiver. Also here, the distance and Doppler may be estimated, but what seems to be the main approach is to consider the channel between the transmitter and the receiver. The channel may in this context be e.g. the frequency response of the entire channel bandwidth occupied by the transmitted signal or the corresponding impulse response. This kind of sensing is sometimes referred to as channel state information, CSI, based.

Finally, it is possible to involve more than two devices in the actual sensing. There may e.g. be one transmitter and several receivers. This may e.g. be the case when the network node is transmitting in the downlink, DL, to two or more devices. Alternatively, there may be two or more transmitters and one receiver. This may e.g. be the case when several devices are transmitting in the uplink, UL, to the network node. It can here be noted that the transmissions from several transmitters to one receiver may or may not take place at the same time. As one example, the UL transmissions may be done concurrently using orthogonal frequency division multiple access, OFDMA, or it may be done sequentially where one device at a time is transmitting in the UL to the network node.

When performing wireless sensing, the goal is to estimate the channel or possibly how the channel changes from a first instant of time to a second instant of time. Sensing a large area with high accuracy comes with several challenges. One of these challenges is how this can be done in a power and spectrum efficient way. Because sensing is typically done at the expense of reduced communication capacity, achieving accurate sensing without using too many resources is expected to become increasingly important in the future, but is currently not the main focus within the area of JCAS.

### SUMMARY

It is an object of the present disclosure to provide for a method of performing sensing measurements between a wireless station, STA, and an access point assembly, AP assembly, wherein the access point assembly is arranged to communicate with said STA using two distinct frequency bands. It is a further object of the present disclosure to provide for a corresponding AP assembly as well as a corresponding computer program product.

In a first aspect, there is provided a method of performing sensing measurements between a wireless station, STA, and an access point assembly, AP assembly in a wireless communication network, wherein the access point assembly is arranged to communicate with said STA using two distinct frequency bands, said method comprising the steps of:
determining, by said AP assembly, which of said two distinct, (/disjoint), frequency bands to use for performing said sensor measurements;
I performing, by said AP assembly, said sensing measurements on said determined distinct frequency band.

The inventors have found that it might be beneficial if sensing measurement may be performed in two distinct frequency bands. The AP assembly is thus arranged to perform sensing measurement in the first frequency band, in the second frequency band, or in both the first and second frequency band.

The step of determining is performed to select the frequency band in which the sensing measurements are to be performed. Such a decision may be based on a plurality of factors, as will be described later below.

A frequency band is a range of frequencies within the electromagnetic spectrum that are used for a specific purpose. For example, the radio frequency spectrum is divided into a number of bands, including the low frequency, LF, band, the medium frequency, MF, band, the high frequency, HF, band, the Ultra high frequency band, Radio Frequency, RF, etc. Each of these bands is used for different types of communication, such as AM and FM radio, television broadcasting, WiFi, telecommunications, and satellite communication, for example.

A frequency channel, on the other hand, is a specific frequency or range of frequencies within a frequency band that is used to transmit a particular type of information. For example, in a WiFi, a frequency channel might be a specific frequency or range of frequencies that is used to transmit data. In a cellular telephone system, a frequency channel might be a specific frequency or range of frequencies that is used to transmit a call or data between two User Equipment, UE.

In summary, a frequency band is a broad range of frequencies that is used for a specific purpose, while a frequency channel is a specific frequency or range of frequencies within a frequency band that is used for a specific type of communication.

Wi-Fi is a type of wireless communication that operates in the RF spectrum, specifically in the ISM bands. There are several frequency bands that are commonly used for Wi-Fi communication, including:
2.4 GHz band: This band is used by many Wi-Fi devices and is typically the most crowded of the Wi-Fi bands. It is used by devices such as phones, laptops, and tablets, as well as other devices such as baby monitors, cordless phones, and smart home devices.

5 GHz band: This band is typically less crowded than the 2.4 GHz band and can offer faster speed, but has a shorter range. It is used by newer Wi-Fi devices that support dual-band operation, which means they can operate on both the 2.4 GHz and 5 GHz bands.

6 GHz band: This band has been opened up for unlicensed use and is expected to be used by Wi-Fi devices more and more in the future. It may offer even faster speed and more capacity than the 5 GHz band.

It is expected that WiFi will use even higher frequency bands in the future, for example 50 GHz or 60 GHz. One of the benefits of using such high frequencies is that they may support higher bandwidths. One of the downsides of using such high frequencies is related to the fact that the signals are more easily attenuated by obstacles than signals at low frequencies.

In an example, the AP assembly comprises a plurality of spatially distributed sensors, wherein each of said plurality of spatially distributed sensors is arranged for performing said sensing measurements.

The present disclosure may especially be suitable in situations wherein the Access Point assembly comprises a plurality of access points. One access point is using a relatively low frequency band, for example 2.4 GHz, 5 GHz or 6 GHz, such that the coverage of that particular access point is quite good. The coverage may, for example, include a particular house or the like.

The house may consist of a plurality of rooms, wherein each of the rooms is equipped with a further access point, wherein each further access point is arranged to operate in a high frequency band, for example 50 GHz or 60 GHz. These kinds of frequencies may be severely attenuated by walls, and may quickly decay such that access points need to be provided per room in order to obtain good coverage at these high frequencies.

The AP assembly may then determine whether the sensing measurements are to be performed by any of the further access points, i.e. the ones operating in the high frequency band, or whether the sensing measurements are to be performed by the access point using the relatively low frequency band. Again, such a decision may be based on a plurality of parameters.

In accordance with the present disclosure, an AP assembly may consist of a single Access Point, AP, wherein that single AP is arranged to communicate with said STA using two distinct frequency bands. In an alternative scenario, the AP assembly comprises a plurality of AP's spatially distributed to one another. At least one of those AP's is then arranged to communicate with the STA using a first of the two distinct frequency bands and other AP's are arranged to communicate with the STA using a second of the two distinct frequency bands.

The AP assembly may thus comprise multiple AP's that work together. They may be connected to one another via a wired backbone, or may be connected to one another using a wireless connection. Each AP may be arranged to cover a particular room of a house, for example.

In an example, the step of determining which of said two distinct, (/disjoint), frequency bands to use is based on any of:
channel bandwidths within said two frequency bands;
carrier frequency within said two frequency bands;
power consumption of performing said sensing measurements for said two frequency bands;
accuracy of performing said sensing measurements.

In a further example, the method further comprises the step of:
determining, by said AP assembly, that said sensed measurements meet a predefined condition;
performing, by said AP assembly, further sensing measurements on said other of said two distinct frequency bands.

The above identified predefined condition may, for example, relate to movement of the STA. In case it is has been detected that the STA has moved to another position, it may be beneficial to perform the further sensing measurements on the other of the two distinct frequency bands as well. Movement of the STA may indicate that the measurements with respect to the other of the two distinct frequency bands may need to be updated, i.e., they may not be accurate anymore.

This is especially the case when the other of the two distinct frequency bands is a very high frequency band, for example in the range of 50 GHz or 60 GHz. The 50 GHz or 60 GHz channel between the corresponding AP and the STA may heavily depend on the location of the STA relative to the AP. As such, the properties of the channel may fluctuate not only over time, but also over the location of the STA with respect to the corresponding AP.

Following the above, another predefined condition may relate to the time that has been elapsed since the last time the other of the two frequency bands was used for performing the sensing measurements. The corresponding channels may be time selective such that it might be worthwhile to perform sensing measurements once the so-called coherence time of the channel is exceeded. This would imply that the characteristics of the channel have changed so that the channel characteristics obtained at the earlier moment in time essentially does not contain any useful information about the channel characteristics at the later moment in time such that the sensing measurements may be performed again to update the results.

In a detailed example of the above, the method further comprises any of the subsequent steps of:
deactivating, by said AP assembly, said performing of said sensing measurements on said determined distinct frequency band;
combining, by said AP assembly, said sensed measurements and said further sensed measurements.

The AP assembly may deactivate the performing of the sensing measurement on the determined distinct frequency band once it also performs sensing measurements on the other frequency band. For example, sensing measurements may be performed on the 50 GHz or 60 GHz band such that it may be superfluous to also perform sensing measurement on the 2.4 GHz band. The AP assembly will then stop sensing the 2.4 GHz band.

A typical example of the above is when the STA is close to an AP that is arranged to communicate on the 50 GHz or 60 GHz band and, at the same time, quite some distance away from an AP that is arranged to communicate on the 2.4 GHz band. This would mean that the channel corresponding to the 50 GHz or 60 GHz frequency band is of much higher quality compared to the channel corresponding to the 2.4 GHz frequency band. In such a case, it may be decided to deactivate performing of the sensing measurement on the 2.4 GHz frequency band, as this would not have a significant contribution.

The above described example may be applicable in scenarios wherein the AP assembly comprises multiple APs that are spatially distributed.

Another option is that the AP assembly combines the sensed measurements. This may improve the accuracy of the sensed measurements.

In a further example, the method further comprises:
determining, by said AP assembly, which of said plurality of spatially distributed sensors to use for performing said further sensing measurement,
wherein said step of performing said further sensing measurements is performed by said determined sensors.

This specific example may be directed to the scenario in which one AP is arranged to communicate on a relatively low frequency band, e.g. the 2.4 GHz-6 GHz bands, and where multiple other access points (i.e. sensors) are arranged to operate in a relatively high frequency band, for example the 50 GHz or 60 GHz band. In such a scenario, the AP assembly may determine which of the further access points to activate to perform the sensing measurements in the relatively high frequency band. It is likely that just one, or maybe two, of those further access points are actually in coverage range of the STA, such that the AP assembly may select only those that are in coverage range.

In another example, the AP assembly comprises:
an access point arranged to communicate with said STA on a first of said two frequency bands;
a plurality of further access points, wherein each of said further access points is arranged to communicate with said STA on a second of said two frequency bands, wherein a carrier frequency of said first frequency band is lower than a carrier frequency of said second frequency band.

In a second aspect of the present disclosure, there is provided an access point assembly arranged for performing sensing measurements between a wireless station, STA, and said access point assembly, AP assembly, wherein the access point assembly is arranged to communicate with said STA using two distinct, frequency bands, wherein said AP comprises:
process equipment arranged for determining which of said two distinct frequency bands to use for performing said sensor measurements;
perform equipment arranged for performing said sensing measurements on said determined distinct frequency band.

It is noted that the advantages as explained with respect to the first aspect, being the method of performing sensing measurements are also applicable to the second aspect, being access point assembly arranged for performing sensing measurements in a Wireless Communication Network.

It is noted that the sensing measurements may be obtained for estimating the quality of the channel between the STA and the AP for, for example, handover purposes. Another option is to establish whether the STA is moving around to proactively suspect the STA to be handed over to another AP. In yet another example, the sensing is performed to ultimately perform load balancing between the different APs. Yet another option includes tracking of the STA through the environment.

In an example, the AP assembly comprises a plurality of spatially distributed sensors, wherein each of said plurality of spatially distributed sensors is arranged for performing said sensing measurements.

In a further example, the process equipment is further arranged for determining which of said two distinct frequency bands to use based on any of:
channel bandwidths within said two frequency bands;
carrier frequency within said two frequency bands;
power consumption of performing said sensing measurements for said two frequency bands;
accuracy of performing said sensing measurements.

In another example, the process equipment is further arranged for determining that said sensed measurements meet a predefined condition, and wherein said perform equipment is further arranged for performing further sensing measurements on said other of said two distinct frequency bands.

In an even further example, the process equipment is further arrange for any of
deactivating said performing of said sensing measurements on said determined distinct frequency band;
combining said sensed measurements and said further sensed measurements.

In another example, the process equipment is further arranged for determining which of said plurality of spatially distributed sensors to use for performing said further sensing measurement,

And wherein said determined sensors are arranged for performing said further sensing measurements.

In another example, the access point assembly comprises:
an access point arranged to communicate with said STA on a first of said two frequency bands;
a plurality of further access points, wherein each of said further access points is arranged to communicate with said STA on a second of said two frequency bands, wherein a carrier frequency of said first frequency band is lower than a carrier frequency of said second frequency band.

In a third aspect of the present disclosure, there is provided a computer program product comprising a computer readable medium having instructions stored thereon which, when executed by an access point assembly, cause said access point assembly to implement a method in accordance with any of the examples as provided above.

In addition to the above, there is provided an access point assembly arranged for performing sensing measurements between a wireless station, STA, and said access point assembly, AP assembly in a wireless communication network, wherein the access point assembly is arranged to communicate with said STA using two distinct frequency bands, wherein said AP comprises:
process module for determining which of said two distinct frequency bands to use for performing said sensor measurements;
perform module for performing said sensing measurements on said determined distinct frequency band.

In further addition to the above, there is provided an access point assembly comprising a processor and a memory, wherein the memory comprises instructions which, when executed by the processor, cause the access point assembly to implement a method in accordance with any of the examples as provided above.

The present disclosure is described in conjunction with the appended figures. It is emphasized that, in accordance with the standard practice in the industry, various features are not drawn to scale. In fact, the dimensions of the various features may be arbitrarily increased or reduced for clarity of discussion.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

The above and other aspects of the disclosure will be apparent from and elucidated with reference to the examples described hereinafter.

### BRIEF DESCRIPTION OF THE FIGURES

FIG. 1 discloses an example of a frequency band which encompasses multiple frequency channels;

FIG. 2 discloses an example of a particular scenario in which the present disclosure may be deployed;

FIG. 3 discloses an example of a method in accordance with the present disclosure;

FIG. 4 discloses an example of an access point in accordance with the present disclosure.

### DETAILED DESCRIPTION

It is noted that in the description of the figures, same reference numerals refer to the same or similar components performing a same or essentially similar function.

A more detailed description is made with reference to particular examples, some of which are illustrated in the appended drawings, such that the features of the present disclosure may be understood in more detail. It is noted that the drawings only illustrate typical examples and are therefore not to be considered to limit the scope of the subject matter of the claims. The drawings are incorporated for facilitating an understanding of the disclosure and are thus not necessarily drawn to scale. Advantages of the subject matter as claimed will become apparent to those skilled in the art upon reading the description in conjunction with the accompanying drawings.

The ensuing description above provides preferred exemplary embodiment(s) only, and is not intended to limit the scope, applicability, or configuration of the disclosure. Rather, the ensuing description of the preferred exemplary embodiment(s) will provide those skilled in the art with an enabling description for implementing a preferred exemplary embodiment of the disclosure, it being understood that various changes may be made in the function and arrangement of elements, including combinations of features from different embodiments, without departing from the scope of the disclosure.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, electromagnetic, or a combination thereof. Additionally, the words “herein,” “above,” “below,” and words of similar import, when used in this application, refer to this application as a whole and not to any particular portions of this application. Where the context permits, words in the Detailed Description using the singular or plural number may also include the plural or singular number respectively. The word “or,” in reference to a list of two or more items, covers all of the following interpretations of the word: any of the items in the list, all of the items in the list, and any combination of the items in the list.

These and other changes can be made to the technology in light of the following detailed description. While the description describes certain examples of the technology, and describes the preferred modes contemplated, no matter how detailed the description appears, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the Detailed Description section explicitly defines such terms. Accordingly, the actual scope of the technology encompasses not only the disclosed examples, but also all equivalent ways of practicing or implementing the technology described by the claims.

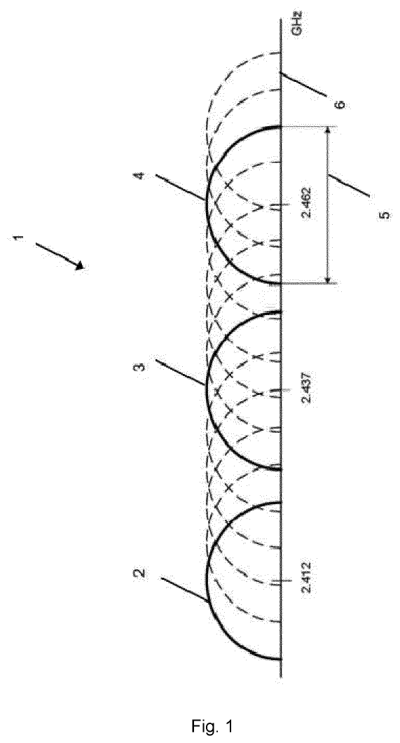

FIG. 1 discloses an example 1 of a frequency band which encompasses multiple frequency channels.

In this particular example, the frequency band is the 2.4 GHz frequency band that is used for Wi-Fi communication.

The frequency band has 13 frequency channels that are placed along the frequency axis. The bandwidth 5 of a frequency channel is, roughly, 20 MHz. The total frequency span of the 2.4 GHz band, for 13 channels, is 2,401 GHz-2,483 GHz. For example, the centre frequency of the first channel is 2,412 GHz, the centre frequency of the sixth channel is 2,437 GHz and the centre frequency of the 11^{th} channel is 2,462 GHz.

Many of the frequency channels overlap with one another. Frequency channels 1, 6 and 11 do not overlap, which is indicated with reference numerals 2, 3, 4.

In accordance with the present disclosure, the frequency band is thus considered to consist of a collection of frequency channels. The frequency band may thus comprise a plurality of frequency channels.

To ease the description of the present disclosure, the disclosure is exemplified for being used with IEEE 802.11bf standard. The disclosure is by no means limited to being used with this standard, but is equally applicable for other standards as well as for proprietary solutions. Some of the described features or steps may need to be part of the actual standard in order to guarantee interoperability, whereas other features and steps may be part of a proprietary solution without any need for being standardized.

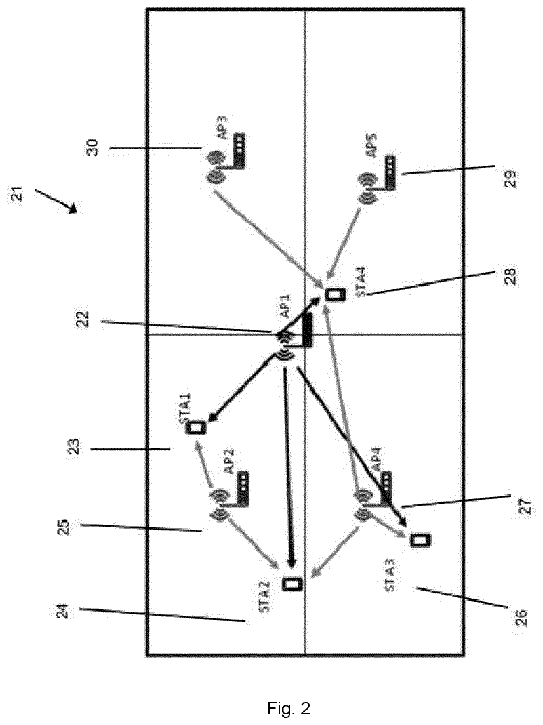

To appreciate the merits of the disclosure, reference is first made to FIG. 2. This figure shows a scenario where one access point, AP1—reference numeral 22—, is using the 6 GHz band and whose coverage is the entire house 21. The house consists of four rooms, each room having an AP, i.e. AP2—reference numeral 25—, AP3—reference numeral 30—, AP4—reference numeral 27—and AP5—reference numeral 29—, operating in the 60 GHz band.

The coverage area of the APs having reference numerals 25, 27, 29, 30 operating in the 60 GHz band is notably smaller and is about the size of a room or slightly larger. There are also four STAs in the figure, STA1—reference numeral 23—, STA2—reference numeral 24—, STA3—reference numeral 26—and STA4—reference numeral 28. This may be considered as four different STAs or alternatively as one STA but observed at four different moments in time.

First, note that since all STAs are within coverage of AP1 due the usage of the 6 GHz band, it is possible to perform sensing using this AP1 throughout the entire house. Specifically, even if the sensing accuracy of the sensing using AP1 is somewhat poor due to that the bandwidth of a channel in the 6 GHz band may be limited to, say, 20, 40 or 80 MHz, it is still assumed that the sensing accuracy suffices to determine roughly in what room the corresponding STA is positioned.

Consider STA1, which is in the upper left room. Once this position is determined by AP1, AP2 is activated and AP2 is used to perform sensing related to STA1 using the 60 GHz band. The sensing may be mono-static, i.e., both the sensing transmitter and the sensing receiver are located in AP2. This essentially means that STA1 is passive and does not need to be aware of that sensing is going on. Alternatively, the sensing may be bi-static, where e.g. the sensing transmitter is located in AP2 and the sensing receiver is located in STA1, or vice versa. In this case STA1 must take active part in the sensing.

It should be emphasized that the sensing application may directly relate to the sensing of the different STAs or it may relate to the sensing of the environment in the vicinity of the different STAs and corresponding APs. Referring to FIG. 2, a scenario where the sensing directly relates to the STAs could be when it is beneficial to determine where the STA is located in order to select which AP is the most suitable AP for the STA to connect to.

However, the four different STAs in FIG. 2 can also be thought of as sensors that are intended for sensing the environment within the house. AP2 may e.g. send packets intended for STA1 if it is desirable to determine whether there is any movement the corresponding room. These packets may e.g. be sent every 100 ms and STA1 may use these packets for determining if the properties of the propagation channel from AP2 to STA1 changes between packets. If such channel changes are detected, it may be concluded that there are movements in the room. Depending on in which part of the building it is desirable to detect movements, a suitable set of APs and STAs may thus be selected.

Following the above, the present disclosure is directed to a method of performing sensing measurements between a wireless station, STA, and an access point assembly, AP assembly in a wireless communication network. The sensing measurements may be related directly to that particular STA. For example, the quality of the wireless channel between the STA and the AP may be used as parameter to decide whether or not to connect that particular STA to that AP, or whether or not to handover (or re-associate) that particular STA to that AP.

The present disclosure also relates to a further application for the sensing measurements. Sensing between a STA and an AP may be performed to characterize, quantify or identify an environmental property, i.e. a property in the vicinity of the AP and/or the STA. Such an environmental property is thus not related to the AP and/or the STA, but relates to the surrounding of the AP and/or the STA.

The obtained sensing measurements between the AP and the STA may thus be used for characterizing, quantifying or identifying an environment property.

An example of an environmental property is related movement. Whenever a person moves within a room of a house, i.e. the room where the AP is located, then such movement may affect the wireless channel between the AP and the STA. It is noted that the person that is moving does not necessarily need to carry the STA. The wireless channel may be affected by any person moving in the room, irrespective of whether that person is carrying a STA or not. Based on the characteristics of the obtained sensing measurements, it may be concluded that some movement in the room has occurred. It is noted that multiple wireless channels, i.e. channels between the same AP with multiple STAs that are in the same room, may be used to more accurately determine that movement has occurred.

Another example of an environmental property is related to the change of composition in the air of a particular room. The air composition is not specifically related to a particular AP or STA. For example, particles in the air can scatter radio waves, causing the signal to become weaker and less stable. Pollution can also cause the air to become more conductive, which can cause the radio waves to be absorbed or reflected instead of being transmitted through the air. This wireless channel(s) may thus be affected when changes in air compositions occur. Based on the characteristics of the obtained sensing measurements, it may be concluded that some predefined environmental property has been met, i.e. related to the air composition.

In the set-up described in FIG. 2, it is assumed that the APs are cooperating and the goal is to use them in an efficient way to perform sensing. For the sake of illustration, it is assumed that irrespective of which one(s) of the APs is involved in the sensing, the sensing results are collected at AP1 where some application is using them. So, if sensing is performed by e.g. AP2, the results are sent to AP1.

The present disclosure may thus further comprise the step of collecting, by one of the APs of the AP assembly, the sensed measurements.

Returning to STA1 and AP2, in case of mono-static sensing AP2 will obtain the sensing data and will thus forward this to AP1. The sensing data may be forwarded without any further processing, or it may be processed first, e.g. some key characteristics may be extracted and then these may be forwarded as a means to reduce the amount of data that needs to be transmitted between AP2 and AP1.

If instead bi-static sensing is used, how to get the data to AP1 will typically depend on whether AP2 is the sensing transmitter or the sensing receiver. If AP2 is the sensing receiver, then AP2 will have the sensing data and can proceed just as in the case of mono-static sensing. If AP2 is the sensing transmitter and STA1 is the sensing receiver, STA1 may either send the result of the sensing to AP2 using the 60 GHz band or to AP1 using the 6 GHz band, which every is considered most suitable.

Next consider STA2. As STA2 is located at similar distances to AP2 and AP4, both these APs are activated. In this case several options exist. Fundamentally, since more than two devices are involved in the sensing, this is multi-static sensing. This may, however, be performed in different ways. AP2 and AP4 may work independently of one another, either by means of mono-static sensing or by bi-static sensing, as described above for STA1. Alternatively, AP2 and AP4 may coordinate their sensing so that e.g. STA2 takes the role of sensing transmitter and AP2 and AP4 take the role of sensing receivers, or vice versa, i.e., the APs take the role of sensing transmitters and STA2 takes the role of sensing receiver.

In this latter case, AP2 and AP4 may transmit using orthogonal resources, e.g. using different parts of the frequency channel, or using the same channel resources. Preferably, the sensing results are collected by AP2 and AP4 and then sent to AP1 for further processing. Just as described for STA1, the sensing results sent to AP1 may or may not be pre-processed before transmission.

STA3 is located close to AP4, and similarly to STA1, it may make sense to only activate one of the 60 GHz APs for performing sensing, i.e., AP4. In case STA 3 would be the only STA for which sensing is to be performed, then AP2, AP3, and AP5 would be turned off or at least set in a low power mode, from which they can be woken up by AP1. If also STA1 and STA 2 would be the target for sensing, then AP2 would also be activated and possibly the sensing of STA1, STA2, and STA3 could be coordinated to reduce the number of sensing packets that need be sent.

Finally, STA 4 is located very close to AP1 and in addition at similar distances to AP2, AP4, and AP5. As a consequence, AP1 may choose to activate all these three 60 GHz APs. However, it may also be so that AP1 determines that only one or two of the 60 GHz APs are needed in order to achieve sensing of sufficient accuracy so that e.g. only AP 5 may be used for sensing in the 60 GHz band. It could potentially also be so that since STA4 is so close to AP1, AP1 determines that there is no need to activate any of the 60 GHz APs.

The preceding description applies equally well if AP1 and AP3 are affiliated with the same Multi Link Device, MLD.

The preceding description is also valid when AP1 operates in 2.4 GHz with for example 30 dBm output power and AP2-4 are Very Low Power, VLP, access points in 6 GHz with for example 14 dBm output power. In fact, the coverage differences between the low and high bands are expected to be of the same order of magnitude.

### Example 1—Effective Sensing Using Two Frequency Bands

According to this example, sensing is performed using two frequency bands with significantly different properties, where the different properties e.g. may be based on the centre frequency of the band or the bandwidth of a channel that can be used in a respective band.

The selection of which one of the frequency bands to use for sensing may then be done based on what properties is considered to be most suitable at that particular moment in time and may depend on various things, like what the sensing application is.

As an example, the two bands may be located around 6 GHz and 60 GHz, respectively, which will result in vastly different propagation properties. Moreover, the channel bandwidth in the 6 GHz may e.g. be 160 MHz whereas the channel bandwidth in the 60 GHz may be e.g. 1 GHz, resulting in that considerably different resolution may be achieved.

According to this example one of the bands, e.g. the one at lower frequency and using lower bandwidth is used as default for sensing any initial movement in an area, and once some movement has been detected, the higher frequency band is used for sensing. The lower band may still be used for sensing and combined with the sensing performed using the higher frequency band or the sensing using the lower frequency band may be inactivated as long as the sensing using the higher frequency band is active.

Typically the total number of sensors in the lower frequency band is smaller than the total number of sensors in the higher frequency band, but the number of activated sensors in the higher frequency band may be smaller than the number of activated sensors in the lower frequency band.

This is for instance the case when the sensors in the lower frequency bands are able to give a relatively accurate position of where the sensing should be performed and thus it may be sufficient to only activate the high frequency sensors that are relatively close to this position.

### Example 2—Band Selection for Sensing Based on Power Consumption

According to this example, which may be viewed as a specific case of Example 1, the selection of frequency band is based on which one of the bands will result in the lowest power consumption. In some cases, where it is desirable to sense a relatively large area, a frequency band at a lower frequency may be selected, as long as sufficient accuracy can be obtained, as typically a lower frequency band allows for that a smaller number of sensors need to be activated and therefore the total power consumption becomes smaller than if a frequency band at a higher frequency would be used.

### Example 3—Using One Frequency Band to Determine which Sensors to Activate in Another Frequency Band

According to this example, sensing in a first frequency band is used to determine which one of the sensors in a second frequency band should be activated.

Typically, the first frequency band is at a lower frequency than the second frequency band. Typically, the sensing in the first frequency band is used to determine which one(s) of the sensors in the second frequency band most likely will result in the most accurate sensing.

Typically, but not necessarily, the selection is based on which one of the sensors in the second frequency band is determined to be closest to the area where sensing is to be performed. In case it is determined that one of the sensors in the second frequency band will give much better sensing results than any of the other sensors in the second frequency band, then typically only this sensor is activated whereas all the other sensors operating in the second frequency band remain inactive.

On the other hand, if it is determined that two or more sensors will have similar sensing performance two or more sensors that are determined to have similar sensing performance may be activated.

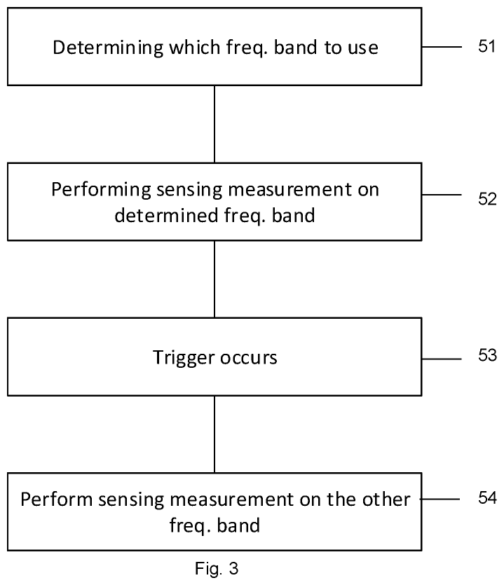

FIG. 3 discloses an example of a method in accordance with the present disclosure.

FIG. 3 discloses a method of performing sensing measurements between a wireless station, STA, and an access point assembly, AP assembly in a wireless communication network, wherein the access point assembly is arranged to communicate with said STA using two distinct, (disjoint), frequency bands, said method comprising the steps of:
determining 51, by said AP assembly, which of said two distinct frequency bands to use for performing said sensor measurements;
performing 52, by said AP assembly, said sensing measurements on said determined distinct frequency band;

In case a particular trigger occurs 53, for example when the sensed measurements meet certain preconditions, a further sensing measurement may be performed on the other of the two frequency bands 54.

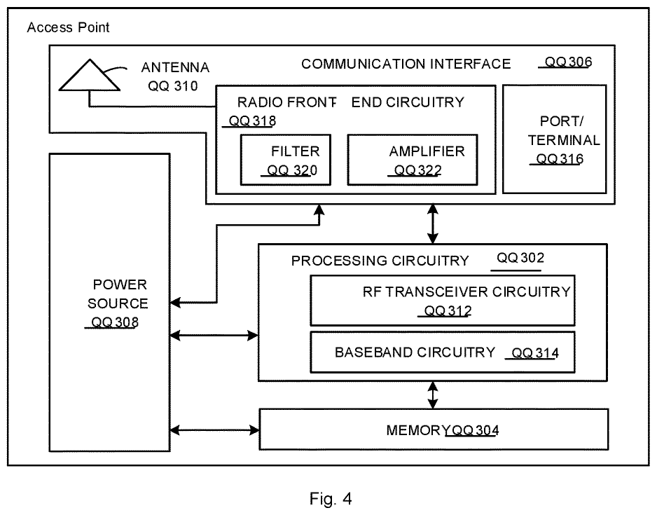

FIG. 4 discloses an example of an access point in accordance with the present disclosure, wherein the AP assembly comprises one or more of those APs.

The AP assembly is arranged for performing sensing measurements between a wireless station, STA, and said access point assembly, AP assembly in a wireless communication network, wherein the access point assembly is arranged to communicate with said STA using two distinct frequency bands.

The AP comprises a processor QQ302 and a memory QQ304, said memory QQ304 containing instructions executable by said processor QQ302.

The processor QQ302 may further comprise a transceiver QQ312 and baseband circuitry QQ314. The communication interface QQ306 may comprise an antenna QQ310 connected to a radio front-end circuitry QQ318 having a filter QQ320 and an amplifier QQ322, and further comprises a terminal QQ316.

All the above features may be connected to a power source QQ308 for powering the AP.

To reduce the number of claims, certain aspects of the technology are presented below in certain claim forms, but the applicant contemplates the various aspects of the technology in any number of claim forms. For example, while some aspect of the technology may be recited as a computer-readable medium claim, other aspects may likewise be embodied as a computer-readable medium claim, or in other forms, such as being embodied in a means-plus-function claim.

In the description above, for the purposes of explanation, numerous specific details are set forth in order to provide a thorough understanding of implementations of the disclosed technology. It will be apparent, however, to one skilled in the art that embodiments of the disclosed technology may be practiced without some of these specific details.

Other variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope thereof.

1.-15. (canceled)

16. A method of performing sensing measurements between a wireless station, STA, and an access point assembly, AP assembly, in a wireless communication network, the AP assembly being arranged to communicate with the STA using two distinct frequency bands, the method comprising:
determining, by the AP assembly, which of the two distinct, frequency bands to use for performing the sensing measurements;
performing, by the AP assembly using one or more first sensors, the sensing measurements on the determined distinct frequency band to obtain sensed measurements;
determining, by the AP assembly, that the sensed measurements meet a predefined condition;
performing, by the AP assembly using one or more second sensors, further sensing measurements on the other of the two distinct frequency bands; and
sensing in a first frequency band of the distinct frequency bands to determine which of the second sensors in a second frequency band of the distinct frequency bands is to be activated.

17. The method of claim 16, wherein the AP assembly comprises a plurality of spatially distributed sensors, wherein each of the plurality of spatially distributed sensors is arranged for performing the sensing measurements.

18. The method of claim 17, wherein the determining which of the two distinct frequency bands to use is based on any of:
channel bandwidths within the two frequency bands;
carrier frequency within the two frequency bands;
power consumption of performing the sensing measurements for the two frequency bands; and
accuracy of performing the sensing measurements.

19. The method of claim 17, wherein the method further comprises any of the subsequent steps of:
deactivating, by the AP assembly, the performing of the sensing measurements on the determined distinct frequency band; and
combining, by the AP assembly, the sensed measurements and the further sensed measurements.

20. The method of claim 17, wherein the AP assembly comprises:
an access point arranged to communicate with the STA on a first of the two frequency bands; and
a plurality of further access points, wherein each of the further access points is arranged to communicate with the STA on a second of the two frequency bands, wherein a carrier frequency of the first frequency band is lower than a carrier frequency of the second frequency band.

21. The method of claim 17, wherein the method further comprises:
any of:
deactivating, by the AP assembly, the performing of the sensing measurements on the determined distinct frequency band; and
combining, by the AP assembly, the sensed measurements and the further sensed measurements; and
determining, by the AP assembly, which of the plurality of spatially distributed sensors to use for performing the further sensing measurement, wherein performing the further sensing measurements is performed by the determined sensors.

22. The method of claim 16, wherein the determining which of the two distinct frequency bands to use is based on any of:
channel bandwidths within the two frequency bands;
carrier frequency within the two frequency bands;
power consumption of performing the sensing measurements for the two frequency bands; and
accuracy of performing the sensing measurements.

23. The method of claim 16, wherein the method further comprises any of the subsequent steps of:
deactivating, by the AP assembly, the performing of the sensing measurements on the determined distinct frequency band; and
combining, by the AP assembly, the sensed measurements and the further sensed measurements.

24. The method of claim 16, wherein the AP assembly comprises:
an access point arranged to communicate with the STA on a first of the two frequency bands; and
a plurality of further access points, wherein each of the further access points is arranged to communicate with the STA on a second of the two frequency bands, wherein a carrier frequency of the first frequency band is lower than a carrier frequency of the second frequency band.

25. An access point assembly arranged for performing sensing measurements between a wireless station, STA, and the access point assembly, AP assembly, in a wireless communication network, wherein the access point assembly is arranged to communicate with the STA using two distinct frequency bands, wherein the AP comprises:
process equipment configured to determine which of the two distinct frequency bands to use for performing the sensing measurements;
perform equipment configured to perform the sensing measurements using one or more first sensors on the determined distinct frequency band to obtain sensed measurements;
the process equipment being further configured to determine that the sensed measurements meet a predefined condition, and the perform equipment being further configured to perform further sensing measurements using one or more second sensors on the other of the two distinct frequency bands; and
sensing in a first frequency band of the distinct frequency bands is used to determine which of the second sensors in a second frequency band of the distinct frequency bands should be activated.

26. The access point assembly of claim 25, wherein the AP assembly comprises a plurality of spatially distributed sensors, wherein each of the plurality of spatially distributed sensors is configured to perform the sensing measurements.

27. The access point assembly of claim 26, wherein the process equipment is further arranged for determining which of the two distinct frequency bands to use based on any of:
channel bandwidths within the two frequency bands;
carrier frequency within the two frequency bands;
power consumption of performing the sensing measurements for the two frequency bands; and
accuracy of performing the sensing measurements.

28. The access point assembly of claim 26, wherein the process equipment is further configured for any of:
deactivating the performing of the sensing measurements on the determined distinct frequency band; and
combining the sensed measurements and the further sensed measurements.

29. The access point assembly of claim 26, wherein:
the process equipment is further configured for any of:
deactivating the performing of the sensing measurements on the determined distinct frequency band; and
combining the sensed measurements and the further sensed measurements; and
wherein the process equipment is further configured to determine which of the plurality of spatially distributed sensors to use for performing the further sensing measurement, and wherein the determined sensors are configured to perform the further sensing measurements.

30. The access point assembly of claim 25, wherein the access point assembly comprises:
an access point configured to communicate with the STA on a first of the two frequency bands; and
a plurality of further access points, wherein each of the further access points is configured to communicate with the STA on a second of the two frequency bands, wherein a carrier frequency of the first frequency band is lower than a carrier frequency of the second frequency band.

31. The access point assembly of claim 25, wherein the process equipment is further arranged for determining which of the two distinct frequency bands to use based on any of:
channel bandwidths within the two frequency bands;
carrier frequency within the two frequency bands;
power consumption of performing the sensing measurements for the two frequency bands; and
accuracy of performing the sensing measurements.

32. The access point assembly of claim 25, wherein the process equipment is further configured for any of:
deactivating the performing of the sensing measurements on the determined distinct frequency band; and
combining the sensed measurements and the further sensed measurements.

33. The access point assembly of claim 25, wherein the access point assembly comprises:
an access point configured to communicate with the STA on a first of the two frequency bands; and
a plurality of further access points, wherein each of the further access points is configured to communicate with the STA on a second of the two frequency bands, wherein a carrier frequency of the first frequency band is lower than a carrier frequency of the second frequency band.

34. A computer storage medium storing a computer program which, when executed by an access point assembly, causes the access point assembly to implement a method of performing sensing measurements between a wireless station, STA, and the AP assembly, the AP assembly being arranged to communicate with the STA using two distinct frequency bands, the method comprising:
determining, by the AP assembly, which of the two distinct, frequency bands to use for performing the sensing measurements;
performing, by the AP assembly using one or more first sensors, the sensing measurements on the determined distinct frequency band to obtain sensed measurements;
determining, by the AP assembly, that the sensed measurements meet a predefined condition;
performing, by the AP assembly using one or more second sensors, further sensing measurements on the other of the two distinct frequency bands; and
sensing in a first frequency band of the distinct frequency bands to determine which of the second sensors in a second frequency band of the distinct frequency bands is to be activated.

35. The computer storage medium of claim 34, wherein the AP assembly comprises a plurality of spatially distributed sensors, wherein each of the plurality of spatially distributed sensors is arranged for performing the sensing measurements.
